(19) United States
(12) Patent Application Publication
(10) Pub. No.: US 2023/0020242 A1
(43) Pub. Date: Jan. 19, 2023

(54) BIOMETRIC IMAGING DEVICE AND ELECTRONIC DEVICE

(71) Applicant: Fingerprint Cards Anacatum IP AB, Göteborg (SE)

(72) Inventors: Hans MARTINSSON, GÖTEBORG (SE); Petter ÖSTLUND, LUND (SE); Jun LIU, SHANGHAI (CN)

(73) Assignee: Fingerprint Cards Anacatum IP AB, Göteborg (SE)

(21) Appl. No.: 17/784,006

(22) PCT Filed: Dec. 15, 2020
(86) PCT No.: PCT/SE2020/051215

§ 371 Date: Jun. 9, 2022

(30) Foreign Application Priority Data
Dec. 18, 2019 (CN) 201922293211.X
Feb. 10, 2020 (SE) 2050140-9

(51) Int. Cl. G06V 40/13; G02B 3/00

(52) U.S. Cl. CPC G06V 40/1318; G02B 3/005; G02B 5/208

(57) ABSTRACT

A biometric imaging device characterized by comprising: an image sensor comprising a plurality of pixels forming a photodetector pixel array; a first aperture layer comprising openings in locations aligned with pixels of the pixel array; a first filter layer comprising a transparent material configured to block light within a predetermined first wavelength range; a transparent spacer layer arranged on the first filter layer, wherein the transparent spacer layer is configured to absorb light within a predetermined second wavelength range; and an array of microlenses arranged on the transparent spacer layer, wherein the microlenses are aligned with the openings in the aperture layer.

### FIELD OF THE INVENTION

The present invention relates to an optical biometric imaging device suitable for integration in a display panel. In particular, the invention relates to an optical biometric imaging device suitable for fingerprint sensing, wherein the sensing device comprises a plurality of microlenses.

### BACKGROUND OF THE INVENTION

Biometric systems are widely used as means for increasing the convenience and security of personal electronic devices, such as mobile phones etc. Fingerprint sensing systems in particular are now included in a large proportion of all newly released consumer electronic devices, such as mobile phones.

Optical fingerprint sensors have been known for some time and may be a feasible alternative to e.g. capacitive fingerprint sensors in certain applications. Optical fingerprint sensors may for example be based on the pinhole imaging principle and/or may employ micro-channels, i.e. collimators or microlenses to focus incoming light onto an image sensor.

US 2007/0109438 describe an optical imaging system which may be used as a fingerprint sensor where microlenses are arranged to redirect light onto a detector. In the described imaging system, each microlens constitutes a sampling point and the microlenses are arranged close to each other to increase the image resolution. To avoid mixing of light received from adjacent microlenses, micro-channels or apertures are arranged between the microlenses and the detector.

However, to achieve a high-resolution sensor, the microlenses will have to be made small and be manufactured with high precision, making the manufacturing process complex and sensitive to variations, and a sensor of the described type comprising small microlenses will also be sensitive to spatial differences in transmissivity in any layer covering the sensor.

Accordingly, it is desirable to provide an improved optical fingerprint sensing device.

### SUMMARY

In view of above-mentioned and other drawbacks of the prior art, it is an object of the present invention to provide an improved biometric imaging device suitable for use under a display cover glass in an electronic user device.

According to a first aspect of the invention, there is provided a biometric imaging device comprising: an image sensor comprising a plurality of pixels forming a photodetector pixel array; a first aperture layer comprising openings in locations aligned with pixels of the pixel array; a first filter layer comprising a transparent material configured to block light within a predetermined first wavelength range; a transparent spacer layer arranged on the first filter layer, wherein the transparent spacer layer is configured to absorb light within a predetermined second wavelength range; and an array of microlenses arranged on the transparent spacer layer, wherein the microlenses are aligned with the openings in the first aperture layer.

The first aperture layer is an opaque layer comprising openings which act to narrow the light beam reaching the pixel, reducing the field of view seen by each collimating structure, i.e. by each lens and aperture combination.

The first filter layer is preferably a layer blocking light in the IR-region, and the transparent material of the filter layer may thereby be referred to as an IR-cut material. The material thus acts as an optical filter which is particularly important when the biometric imaging device is used in sunlight.

The microlenses may for example be arranged in a hexagonal or rectilinear grid arrangement to form the array. Moreover, the microlens array may be formed in a single block or it may be formed as individual lenses arranged in an array.

According to one embodiment of the invention, the transparent spacer layer is a tinted glass layer. The tinted glass layer may also be referred to as a hybrid infrared cut-off filter where the tinted glass is configured to absorb light in the infrared wavelength range and above such that visible light can reach the image sensor. The tinted glass layer can be achieved by incorporating additives to the glass during the manufacturing process, where the additives may be Phosphorous pentoxide (P₂O₅) or Cupric Oxide (CuO). Moreover, by controlling the type and concentration of additive, the light absorbing properties of the tinted glass layer can be controlled.

According to one embodiment of the invention the transparent spacer layer exhibits a gradual increase of light absorption with increasing wavelength such that visible light is transmitted, and infrared light is absorbed. As described above, the absorption profile of the transparent spacer layer can be controlled and tailored by controlling the amount of additives in the layer.

According to an example embodiment of the invention, the transparent spacer layer may have a transmission in the range of 40% to 60% for wavelengths in the range of 600 nm to 700 nm, and wherein light having longer wavelengths is being blocked. Thereby, the transparent spacer layer acts as an infrared cut-off layer to reduce the amount of light in the infrared wavelength range reaching the image sensor.

According to one embodiment of the invention, the biometric imaging device further comprises a second filter layer comprising a transparent material configured to block light within the first wavelength range. The second filter layer helps to further reduce the amount infrared light reaching the image sensor.

According to one embodiment of the invention, the first and second filter layers are arranged on respective sides of the transparent spacer layer. By arranging a filter layer on respective sides of the tinted glass layer, tensions in the glass layer can be reduced, thereby reducing the risk of warping and bending of the transparent spacer layer.

According to one embodiment of the invention, the biometric imaging device further comprises a second aperture layer comprising openings in locations aligned with pixels of the pixel array. The second aperture layer may for example be located above the first aperture layer, in which case the openings in the second aperture layer are larger than openings in the first aperture layer. Thereby, the straylight can be reduced and crosstalk from neighboring lenses reduced significantly. An optically clear adhesive (OCA) may be arranged between the first and second aperture layers in order to connect the layers and to control the distance between the two aperture layers.

According to one embodiment of the invention, the biometric imaging device may further comprise a light blocking layer located between adjacent microlenses. The light blocking layer may be a layer which is arranged as a mask on the transparent spacer layer, or on the second filter layer if such a layer is used. The light blocking layer is configured to prevent light from reaching the imaging device which has not passed through a microlens. Accordingly, the light blocking mask layer preferably covers the entirety of the topmost surface of the imaging device aside from the locations of the microlenses. It is also possible that the light blocking layer slightly overlaps the microlenses, meaning that the openings in the light blocking layer are smaller than the microlenses.

Thereby, the amount of stray light reaching the image sensor potentially disturbing the captured image is reduced. In practice some stray light may be allowable, but it is desirable to reduce the amount of optical “crosstalk” between pixels.

According to one embodiment of the invention the biometric imaging device may further comprise a transparent base layer arranged between the microlenses and the light blocking layer. The transparent base layer may be made from the same material as the microlenses, and the base layer may also be in the same block as the microlenses such that an entire microlens array supported by the base layer can be molded or imprinted in one step.

According to one embodiment of the invention the first and second filter layers may be configured to block light having a wavelength higher than 550 nm, or 570 nm, thereby acting as infrared cut-off layers.

The first aperture layer may be a top metal layer in the image sensor. The image sensor may be manufactured using a CMOS process comprising a plurality of metal layers, and by using the top metal layer of a CMOS chip as an aperture layer, the manufacturing process of the biometric imaging device is simplified since there is no need for an additional step for forming the aperture layer.

The first aperture layer may also be arranged on the image sensor. The aperture layer is then provided as a separate layer arranged on the image sensor. There may also be an additional spacer layer between the image sensor and the aperture layer.

According to one embodiment of the invention the microlenses are configured to have a focal point at the surface of the image sensor. Thereby, reflected light from a portion of a biometric object which is reaching one microlens is being focused onto the image sensor where it can be captured.

The microlenses may also be configured to have a focal point located in the plane of an aperture layer located on the image sensor or as part of the image sensor and directly above the pixels of the image sensor.

There is also provided an electronic device comprising a display screen and a biometric imaging device according to any one of the aforementioned embodiments arranged underneath the display screen. The biometric imaging device may thereby be integrated in or located underneath a display panel so that biometric imaging is made possible over the entire surface of the display. The pixels of the display will then act as light sources for the biometric imaging sensor so that light emitted from the display panel is reflected by a biometric object in contact with an outer surface of the display panel and reflected back towards the image sensor, where an image of the biometric object can be formed. The biometric object may for example be a fingerprint or a palmprint. Moreover, the electronic device may be a smartphone, a tablet computer or the like.

According to a second aspect of the invention, there is provided a biometric imaging device comprising: an image sensor comprising a plurality of pixels forming a photodetector pixel array; a first aperture layer comprising openings in locations aligned with pixels of the pixel array; a transparent spacer layer, wherein the transparent spacer layer is configured to absorb light within a predetermined second wavelength range in the infrared wavelength range; and an array of microlenses, wherein the microlenses are aligned with the openings in the first aperture layer, and wherein the transparent spacer layer is located between the array of microlenses and the aperture layer.

Effects and features of this second aspect of the invention are largely analogous to those above described in relation to the first aspect of the invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates a biometric imaging system according to an embodiment of the invention;

FIG. 2 schematically illustrates a biometric imaging system according to an embodiment of the invention;

FIG. 3 schematically illustrates a biometric imaging system according to an embodiment of the invention; and

FIG. 4 schematically illustrates a biometric imaging system according to an embodiment of the invention.

### DETAILED DESCRIPTION OF EXAMPLE EMBODIMENTS

In the present detailed description, various embodiments of the biometric imaging system according to the present invention are mainly described with reference to a fingerprint imaging sensor suitable for use under a display panel of a consumer device such as a smartphone, tablet computer or the like.

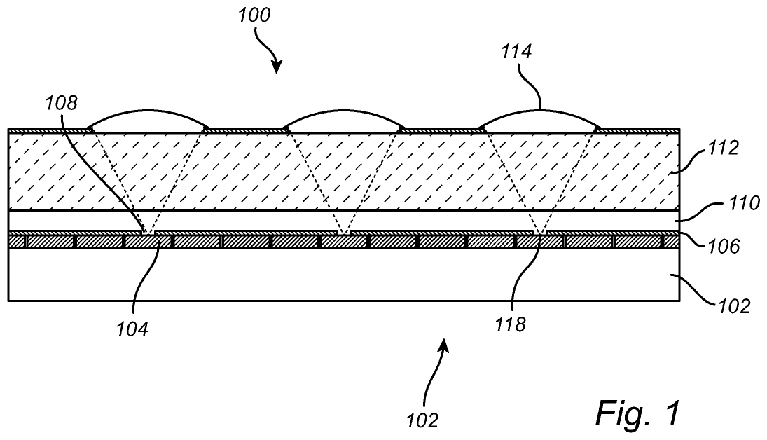

FIG. 1 schematically illustrates a portion of a biometric imaging device 100. In particular, FIG. 1 illustrates a cross section of a portion of the biometric imaging device 100, and it should be understood that the imaging device extends further to form an imaging device of suitable size.

The biometric imaging device 100 comprises an image sensor 102 which in turn comprises a plurality of pixels 104 forming a photodetector pixel array; a first aperture layer 106 comprising openings 108 in locations aligned with pixels 104 of the pixel array. Each opening 108 of the aperture layer 106 is aligned with a pixel 104 of the image sensor 102. The image sensor 102 may however comprise more pixels than apertures such that some of the pixels in the image sensor are not being used.

The first aperture layer 106 may be formed from the topmost metal layer in a CMOS chip in which the image sensor 102 is formed. Thereby, the image sensor 102 and the first aperture layer 106 can be formed in the same manufacturing process.

The biometric imaging device 100 further comprises a first filter layer 110 comprising a transparent material 110 configured to block light within a predetermined first wavelength range and a transparent spacer layer 112, here arranged on the first filter layer 110, wherein the transparent spacer layer 112 is configured to absorb light within a predetermined second wavelength range. In the biometric imaging device 100 illustrated in FIG. 1, the first filter layer 110 is located underneath the transparent spacer layer 112. However, the first filter layer 110 may equally well be located on top of the transparent spacer layer 112 such that the transparent spacer layer 112 is arranged on the first aperture layer 106.

The first filter layer 110 is preferably configured to block at least 50% of light having a wavelength higher than 570 nm. The first wavelength range is thus comprised of wavelengths higher than 570 nm.

Moreover, the biometric imaging device 100 comprises an array of microlenses 114 here arranged on the transparent spacer layer 112, wherein the microlenses 114 are aligned with the openings 118 in the first aperture layer 106. In an embodiment where the first filter layer 110 is arranged on top of the transparent spacer layer 112, the microlens array will be arranged on the first filter layer 110.

In the described embodiment, the transparent spacer layer 112 is a tinted glass layer exhibiting a gradual increase of light absorption with increasing wavelength such that visible light is transmitted, and infrared light is absorbed. The purpose of the transparent spacer layer 112 is thus to reduce the amount of infrared light reaching the image sensor. The total absorption of the transparent spacer layer 112, which may also be referred to as a light absorbing layer, is dependent on the thickness of the layer. It is therefore possible to configure the thickness of the transparent spacer layer to sufficiently reduce optical crosstalk and other internal reflections. The cut-off wavelength of the transparent spacer layer 112, i.e. the wavelength where 50% of the light is absorbed, can be controlled by controlling the composition of the layer. In particular, the transmission properties of a transparent spacer layer 112 can be controlled by selecting the type and amount of additives in a glass material. For an optical fingerprint sensor, it may be desirable to have the cut-off region in the range of 590-630 nm.

The transparent spacer layer may for example have a transmission in the range of 40% to 60% for wavelengths in the range of 600 nm to 700 nm, and wherein light having longer wavelengths is being blocked. The first wavelength range can thus be described as the range of wavelengths above 600 nm. The second wavelength range may also be the same as the first wavelength range.

The difference between the transparent spacer layer 112 and the first filter layer 110 is that the transparent spacer layer 112 in form of a tinted glass layer is configured to absorb infrared light while the first filter layer 110 is configured to block infrared light. A filter layer configured to block light based on interference may have a sharp transmission profile as a function of wavelength and the transmission may also be dependent on the angle of incident light. In a light absorbing layer, the transition is smoother and there is no angular dependence. Accordingly, by combining an absorbing layer with a blocking layer, the advantageous properties of the respective layers can be utilized.

The biometric imaging device 100 may also comprise additional intermediate layers not described herein as long as the layers are sufficiently transparent to allow light to travel from the microlens to the image sensor without excessive losses.

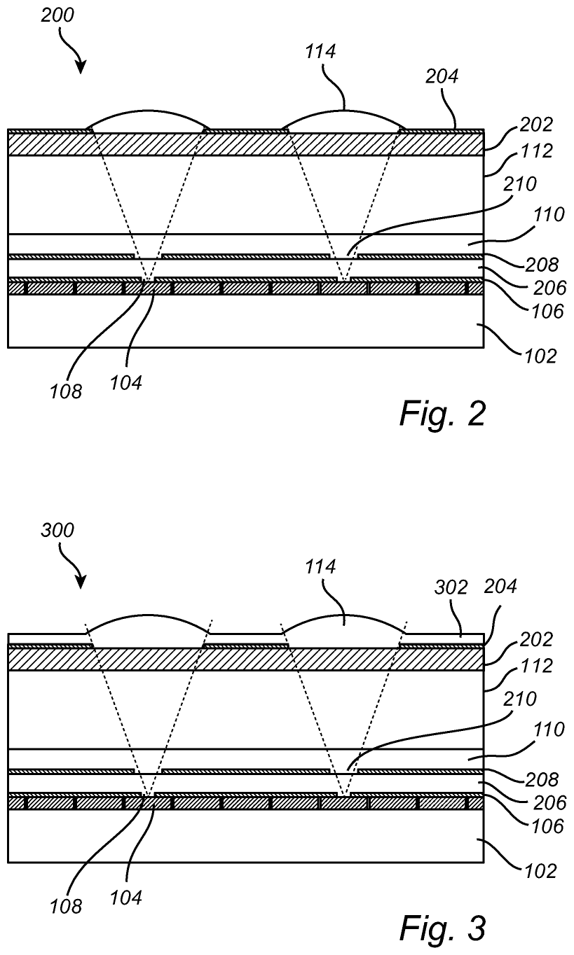

FIG. 2 schematically illustrates a biometric imaging device 200 further comprising a second aperture layer 208 comprising openings 210 in locations aligned with pixels 104 of the pixel array. The openings 210 in the second aperture layer 208 are larger than the openings 108 in the first aperture layer so that the two aperture layers 106, 208 together act to narrow the beam of light reaching the pixel 104. A transparent layer 206, which may be an optically clear adhesive (OCA) layer, is arranged between the first and second aperture layers 106, 208 to define the distance between the layers 106, 208.

The biometric imaging device 200 of FIG. 2 further comprises a second filter layer 202 comprising a transparent material configured to block light within the first wavelength range. The properties of the second filter layer 202 are thus the same as the properties of the first filter layer 110. It may however be possible to provide a second filter layer having different optical properties compared to the first filter layer.

Moreover, the biometric imaging device 200 comprises a light blocking layer 204 located between adjacent microlenses 114. In other words, the light blocking layer 204 comprises openings at the locations of the microlenses 114. The light blocking layer 204 may be deposited on the device before or after the formation of the microlenses 114, and the light blocking layer 204 may be in principle be above the bottom plane of the lenses or in the same plane as the lenses. In either case, the openings of the light blocking layer 204 have a size which is equal to or smaller than the size of the microlens 114. The light blocking layer 204 also allows for a sparse arrangement of microlenses 114 in the microlens array such that there is a distance between adjacent microlenses 114. Thereby, light reaching the image sensor 102 must pass through a microlens 114.

FIG. 3 schematically illustrates a biometric imaging sensor 300 further comprising a transparent base layer 302 arranged between the microlenses 114 and the light blocking layer 204. The transparent base layer 302 may be made from same material as microlenses 114 and it may be formed in one piece together with the microlenses 114.

Further features of the biometric imaging devices 200, 300 of FIGS. 2 and 3 are similar to the features described above with reference to the biometric imaging device 100 of FIG. 1.

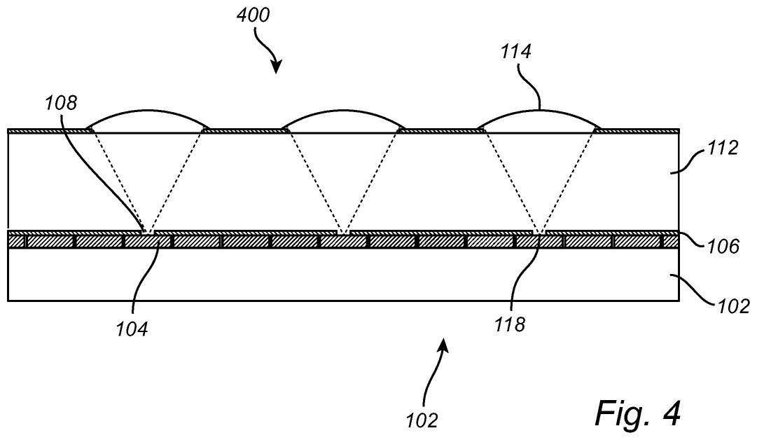

FIG. 4 schematically illustrates a biometric imaging device 400 similar to the device 100 illustrated in FIG. 1. The difference being that the biometric imaging device 400 of FIG. 4 does not comprise the first filter layer 110. Instead, the transparent spacer layer 112 fills the volume between the microlens array 114 and the first aperture layer 106. In some applications, it may be sufficient with only the light absorbing layer in the form of the transparent spacer layer to reduce the amount of infrared light reaching the image sensor. For a light absorbing layer, the amount of absorbed light is proportional to the thickness of the layer, and in some applications the distance between the aperture layer and the microlens array may be sufficiently large for the transparent spacer layer 112 to provide sufficient absorption without the filter layer 110 illustrated in FIG. 1.

Even though the invention has been described with reference to specific exemplifying embodiments thereof, many different alterations, modifications and the like will become apparent for those skilled in the art. Also, it should be noted that parts of the device may be omitted, interchanged or arranged in various ways, the device yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A biometric imaging device comprising:
an image sensor comprising a plurality of pixels forming a photodetector pixel array;
a first aperture layer comprising openings in locations aligned with pixels of the pixel array;
a first filter layer comprising a transparent material configured to block light within a predetermined first wavelength range in the infrared wavelength range;
a transparent spacer layer, wherein the transparent spacer layer is configured to absorb light within a predetermined second wavelength range in the infrared wavelength range; and
an array of microlenses, wherein the microlenses are aligned with the openings in the first aperture layer, and wherein the transparent spacer layer is located between the array of microlenses and the aperture layer.

2. The biometric imaging device according to claim 1, wherein the transparent spacer layer is a tinted glass layer.

3. The biometric imaging device according to claim 1, wherein the transparent spacer layer exhibits a gradual increase of light absorption with increasing wavelength such that visible light is transmitted, and infrared light is absorbed.

4. The biometric imaging device according to claim 1, wherein the transparent spacer layer has a transmission in the range of 40% to 60% for wavelengths in the range of 600 nm to 700 nm, and wherein light having longer wavelengths is being blocked.

5. The biometric imaging device according to claim 1, further comprising a second filter layer comprising a transparent material configured to block light within the first wavelength range.

6. The biometric imaging device according to claim 5, wherein the first and second filter layers are arranged on respective sides of the transparent spacer layer.

7. The biometric imaging device according to claim 1, further comprising a second aperture layer comprising openings in locations aligned with pixels of the pixel array.

8. The biometric imaging device according to claim 7, wherein the openings in the second aperture layer are larger than openings in the first aperture layer.

9. The biometric imaging device according to claim 1, further comprising a light blocking layer located between adjacent microlenses.

10. The biometric imaging device according to claim 9, wherein the light blocking layer is arranged between adjacent microlenses such that light reaching the image sensor must pass through a microlens.

11. The biometric imaging device according to claim 1, further comprising a transparent base layer arranged between the microlenses and the light blocking layer.

12. The biometric imaging device according to claim 5, wherein the first and second filter layers are configured to block at least 50% of light having a wavelength higher than 570 nm.

13. The biometric imaging device according to claim 1, wherein the aperture layer is a top metal layer in the image sensor.

14. The biometric imaging device according to claim 1, wherein the aperture layer is arranged on the image sensor.

15. The biometric imaging device according to claim 1, wherein the microlenses are configured to have a focal point at the surface of the image sensor.

16. An electronic device characterized by comprising:
a display screen; and
a biometric imaging device according to claim 1 arranged underneath the display screen.

17. A biometric imaging device comprising:
an image sensor comprising a plurality of pixels forming a photodetector pixel array;
a first aperture layer comprising openings in locations aligned with pixels of the pixel array;
a transparent spacer layer, wherein the transparent spacer layer is configured to absorb light within a predetermined wavelength range in the infrared wavelength range; and
an array of microlenses, wherein the microlenses are aligned with the openings in the first aperture layer, and wherein the transparent spacer layer is located between the array of microlenses and the aperture layer.
